(19) United States
(12) Patent Application Publication
(10) Pub. No.: US 2008/0026289 A1
(43) Pub. Date: Jan. 31, 2008

(54) Non-aqueous electrolyte secondary battery

(76) Inventors: Koh Masahara, Osaka (JP); Kumiko Kanai, Osaka (JP); Takao Inoue, Nagoya-shi (JP); Masahisa Fujimoto, Osaka (JP)

Correspondence Address: KUBOVCIK & KUBOVCIK, SUITE 710, 900 17TH STREET NW, WASHINGTON, DC, 20006, US

(21) Appl. No.: 11/819,151

(22) Filed: Jun. 25, 2007

(30) Foreign Application Priority Data
Jun. 26, 2006 (JP) 2006-174758

(51) Int. Cl. H01M 10/36; H01M 4/36

(52) U.S. Cl. 429/188

(57) ABSTRACT

A low-cost, high-discharge capacity density non-aqueous electrolyte secondary battery is provided. The battery includes a positive electrode, a non-aqueous electrolyte containing sodium ions, and a negative electrode having a thin-film negative electrode active material containing germanium (Ge) as its main active material or a negative electrode active material comprising particles containing germanium as its main active material.

### FIELD OF THE INVENTION

The present invention relates to a non-aqueous electrolyte secondary battery comprising a positive electrode, a negative electrode, and a non-aqueous electrolyte.

### DESCRIPTION OF RELATED ART

Currently, lithium secondary batteries are widely used as high-energy density secondary batteries. A lithium secondary battery uses a non-aqueous electrolyte and performs charge-discharge operations by transferring ions such as lithium ions between its positive and negative electrodes.

In this type of non-aqueous electrolyte secondary battery, the positive electrode is typically composed of a layered lithium-transition metal composite oxide, such as lithium nickel oxide (LiNiO₂) and lithium cobalt oxide (LiCoO₂), and the negative electrode is typically composed of a material capable of intercalating and deintercalating lithium ions, such as metallic lithium, lithium alloys, and carbon materials (see Japanese Published Unexamined Patent Application No. 2003-151549, for example).

The non-aqueous electrolyte secondary battery generally uses a non-aqueous electrolyte in which an electrolyte salt, such as lithium tetrafluoroborate (LiBF₄) or lithium hexafluorophosphate (LiPF₆), is dissolved in an organic solvent such as ethylene carbonate or diethyl carbonate.

On the other hand, research into non-aqueous electrolyte secondary batteries utilizing sodium ions in place of lithium ions has started recently (for example, see Published Japanese Translation of PCT Application No. 2004-533706). The negative electrode of this non-aqueous electrolyte secondary battery is formed of a metal containing sodium. Since sodium is abundant in seawater, using sodium for the negative electrode leads to lower cost.

Since the charge-discharge reactions of the non-aqueous electrolyte secondary battery utilizing sodium are performed by dissolution and deposition of sodium ions, the charge-discharge efficiency and charge-discharge characteristics of the batteries tend to be poor.

Moreover, when the charge-discharge operations are repeated, tree-like deposits (dendrites) tend to form easily in the non-aqueous electrolyte. The dendrites can cause internal short circuits. Therefore, ensuring sufficient safety is difficult.

Furthermore, when a negative electrode containing carbon, which is capable of intercalating and deintercalating lithium ions and is highly practical, is used for the non-aqueous electrolyte secondary battery utilizing sodium ions, this negative electrode cannot occlude or release sodium ions sufficiently, making it impossible to obtain a high charge-discharge capacity density. Likewise, when a negative electrode containing silicon is used, the negative electrode cannot occlude or release sodium ions.

### BRIEF SUMMARY OF THE INVENTION

It is an object of the present invention to provide a low-cost non-aqueous electrolyte secondary battery capable of achieving a high discharge capacity density.

(1) In accordance with a first aspect, the present invention provides a non-aqueous electrolyte secondary battery comprising: a positive electrode; a non-aqueous electrolyte containing sodium ions; and a negative electrode having a negative electrode active material layer, the negative electrode active material layer containing germanium as its main active material and having a thickness of 8 μm or less.

It should be noted that the term “main active material” herein is intended to mean an active material that accounts for greater than 50 mass % of the electrode active material.

The non-aqueous electrolyte secondary battery in accordance with the first aspect of the invention employs the negative electrode active material layer containing germanium as its main active material and having a thickness of 8 μm or less. Therefore, the sodium ions in the non-aqueous electrolyte are occluded into and released from the negative electrode sufficiently. This makes it possible to perform reversible charge-discharge operations.

Moreover, by setting the thickness of the negative electrode active material layer to be 8 μm or less, it becomes possible to obtain a high discharge capacity density.

Furthermore, the use of sodium, which is an abundant natural resource, serves to reduce the cost of the non-aqueous electrolyte secondary battery.

(2) The negative electrode active material layer may be formed in a thin film by sputtering. In this case, the use of sputtering to form the negative electrode active material layer on the negative electrode current collector allows the germanium sputtered from the target to reach and deposit on the surface of the negative electrode current collector in substantially a monatomic state. Thereby, a uniform polycrystalline germanium thin film can be formed. For this reason, the use of sputtering is preferable over evaporation, by which a plurality of germanium atoms reaches the surface of the negative electrode current collector in a clustered and aggregated state and deposits thereon in that state.

(3) In accordance with a second aspect, the present invention provides a non-aqueous electrolyte secondary battery comprising: a positive electrode; a non-aqueous electrolyte containing sodium ions; and a negative electrode having a negative electrode active material layer, the negative electrode active material layer containing germanium having a particle size of 16 μm or less as its main active material.

The non-aqueous electrolyte secondary battery in accordance with the second aspect of the invention employs a negative electrode active material layer containing germanium having a particle size of 16 μm or less as its main active material. Therefore, the sodium ions in the non-aqueous electrolyte are occluded into and released from the negative electrode sufficiently. This makes it possible to perform reversible charge-discharge operations.

Moreover, by setting the particle size of germanium in the negative electrode active material layer to be 16 μm or less, it becomes possible to obtain a high discharge capacity density.

Furthermore, the use of sodium, which is an abundant natural resource, serves to reduce the cost of the non-aqueous electrolyte secondary battery.

(4) The negative electrode active material layer may comprise elemental germanium. This makes it possible to obtain a further higher discharge capacity density.

(5) The negative electrode may further comprise a metal current collector having a roughened surface, and the negative electrode active material layer may be formed on the metal current collector having a roughened surface.

When the negative electrode active material layer is formed on the metal current collector having a roughened surface, the formed negative electrode active material layer is made to have a corresponding surface shape to the irregular surface shape of the metal current collector produced by a roughening process.

When a battery that uses either the negative electrode active material layer containing germanium as its main active material and having a thickness of 8 μm or less or the negative electrode active material layer containing germanium having a particle size of 16 μm or less as its main active material formed on a current collector having a roughened surface undergoes a charge-discharge process, the stress associated with the expansion and shrinkage of the negative electrode active material layer concentrates at the surface irregularities of the negative electrode active material layer, causing a structural change in the negative electrode active material layer and forming gaps in the irregular surface portion of the negative electrode active material layer. Because of these gaps, the stress caused by the charge-discharge process is distributed. Thereby, reversible charge-discharge operations can be performed easily, and good charge-discharge characteristics can be obtained.

(6) The metal current collector may have an arithmetical mean surface roughness of from 0.1 μm to 10 μm. This allows reversible charge-discharge operations to be performed more easily and makes better charge-discharge characteristics available.

(7) The non-aqueous electrolyte may contain sodium hexafluorophosphate. In this case, safety and thermal stability of the non-aqueous electrolyte secondary battery are improved.

Thus, the present invention makes available a low-cost non-aqueous electrolyte secondary battery capable of achieving a high discharge capacity density.

### BRIEF DESCRIPTION OF THE DRAWINGS

FIG. 1 is a schematic view illustrating a sputtering apparatus;

FIG. 2 shows schematic views each illustrating a state of germanium formed on a negative electrode current collector;

FIG. 3 is a schematic drawing illustrating a test cell of a non-aqueous electrolyte secondary battery according to an embodiment of the invention;

FIG. 4 is a two-phase diagram of germanium and sodium;

FIG. 5 is a graph illustrating the charge-discharge characteristics of the non-aqueous electrolyte secondary battery of Example 1; and

FIG. 6 is a graph illustrating the results of charge-discharge tests for Examples 1 to 4 and Comparative Example.

### DETAILED DESCRIPTION OF THE INVENTION

In the non-aqueous electrolyte secondary battery of the present invention, the negative electrode comprises a negative electrode active material layer containing germanium as its main active material. The germanium which is the main active material may be in the form of elemental germanium or a germanium alloy.

Other materials that can be used with the germanium main active material in the negative electrode active material layer are materials that can occlude and release sodium ion and include, for example, a carbon material such as hard carbon, tin, bismuth, sodium and the like.

As the metal current collector of the negative electrode, a material which does not form an alloy with sodium is preferred. Such materials include copper, aluminum, iron, tantalum, niobium and alloys thereof.

Hereinbelow, a non-aqueous electrolyte secondary battery according to one embodiment of the present invention will be described in detail with reference to the drawings.

A non-aqueous electrolyte secondary battery according to the present embodiment comprises a working electrode (negative electrode), a counter electrode (positive electrode), and a non-aqueous electrolyte.

It should be noted that the types of materials and various parameters including thicknesses of the materials, concentrations, and so forth are not limited to those described in the following description, but may be determined as appropriate.

(1) Preparation of Working Electrode

In the present embodiment, a working electrode is prepared in the following manner.

As a negative electrode current collector, a 26 μm-thick pressure-rolled foil, for example, is prepared from a roughened copper with surface irregularities that are produced by depositing copper on its surfaces by an electrolytic process. The arithmetical mean surface roughness, Ra, of the roughened copper foil is 0.25 μm.

Next, either a thin-film negative electrode active material containing germanium (Ge) as its main active material or a negative electrode active material comprising particles containing germanium as its main active material is formed on the negative electrode current collector.

Here, a method for forming a negative electrode active material comprising a polycrystalline germanium thin film on the negative electrode current collector by sputtering will be described.

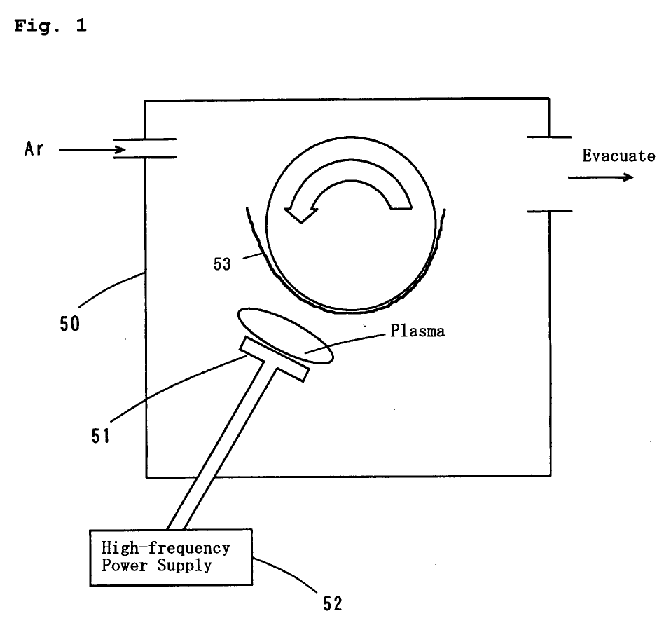

Using a sputtering apparatus as illustrated in FIG. 1, elemental germanium is deposited on the negative electrode current collector formed of the above-described pressure-rolled foil, in the following manner. The conditions of the deposition are shown in Table 1 below.

TABLE 1

| | | | |
|---|---|---|---|
| Sputter | Frequency | 13.56 | MHz |
| source | High-frequency | 200 | W |
| | power | | |

| | | |
|---|---|---|
| Argon flow rate | 50 | sccm |

| | |
|---|---|
| Gas pressure | 1.7 − 1.8 × 10⁻¹ Pa |
| Duration | 30 minutes-15 hours |
| Thickness | 0.5 μm-15 μm |

First, the interior of the chamber 50 is evacuated to 1×10⁻⁴ Pa. Thereafter, argon is introduced into the chamber 50, and the gas pressure is stabilized at 1.7 to 1.8×10⁻¹ Pa.

Next, high-frequency electric power is applied with a high-frequency power supply 52 to a germanium sputter source 51 for a predetermined time with the gas pressure of the interior of the chamber 50 being stabilized. Thereby, a negative electrode active material layer made of a polycrystalline germanium thin film is formed on the negative electrode current collector 53.

When sputtering is used as described above, germanium reaches the surface of the negative electrode current collector 53 in substantially a monatomic state. Thereby, a uniform polycrystalline germanium thin film can be formed. For this reason, the use of sputtering is preferable over evaporation, in which a plurality of aggregated germanium atoms reaches the surface of the negative electrode current collector in a clustered state.

Next, a method for forming a negative electrode active material layer made of germanium particles on the negative electrode current collector will be described below.

Germanium particles are added to a solution in which a polyvinylidene fluoride binder agent is dissolved in N-methyl-2-pyrrolidone. The resultant solution is thereafter kneaded to prepare a slurry as a negative electrode mixture.

Subsequently, the prepared slurry is applied onto the negative electrode current collector by doctor blading, and then dried under vacuum. Thereafter, the resultant material is pressure-rolled using pressure rollers. Thus, a negative electrode active material layer comprising germanium particles is formed.

Here, the state of germanium formed on the negative electrode current collector will be described with reference to the drawings. There are two types of the state of the germanium formed.

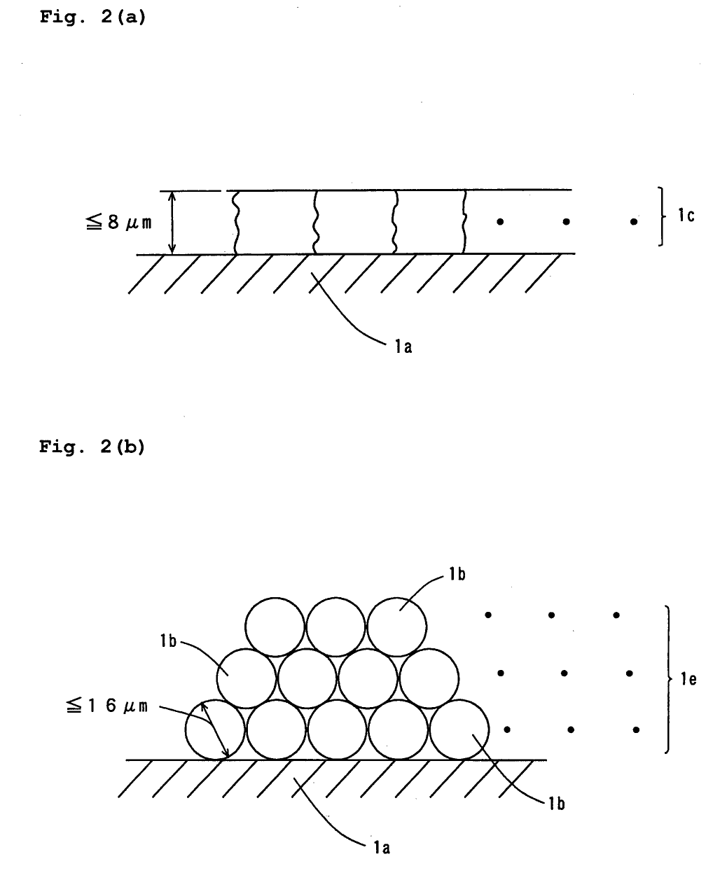

FIG. 2 shows schematic views each illustrating a state of the germanium formed on a negative electrode current collector.

In the example shown in FIG. 2(a), a polycrystalline germanium is formed in a thin film on a negative electrode current collector 1a. The polycrystalline germanium thin film constitutes a negative electrode active material layer 1c. Accordingly, in the example shown in FIG. 2(a), the thickness of the negative electrode active material layer 1c equates to the thickness of the polycrystalline germanium thin film. This negative electrode active material layer 1c can be obtained by the above-mentioned sputtering. In other words, the negative electrode active material layer 1c is formed on the negative electrode current collector 1a.

Since the ionic radius of sodium ion is greater than the ionic radius of lithium ion, sodium ions do not easily diffuse into the negative electrode active material layer 1c. Taking this into consideration, the thickness of the polycrystalline germanium thin film is set to be 8 μm or less.

In the example shown in FIG. 2(b), a plurality of particles 1b of germanium are formed on a negative electrode current collector 1a so as to be in close contact with one another. An aggregate of a plurality of particles 1b constitutes a negative electrode active material layer 1e. This negative electrode active material layer 1e can be obtained by applying a plurality of particles 1b onto the negative electrode current collector 1a.

Since the ionic radius of sodium ion is greater than the ionic radius of lithium ion, sodium ions do not easily diffuse into the negative electrode active material layer 1e. Taking this into consideration, the particle size (diameter) of each particle 1b is set to be 16 μm or less. The reason why the particle size of the particle 1b is set to be 16 μm or less is as follows.

As illustrated in FIG. 2(a), in the case of the negative electrode active material layer 1c that is deposited on the negative electrode current collector 1a, sodium ions diffuse from the side of the negative electrode active material layer 1c that is not in contact with the negative electrode current collector 1a (from the top side in FIG. 2(a)). On the other hand, in the case of the example shown in FIG. 2(b), sodium ions diffuse from any direction in the negative electrode active material layer 1e, and therefore, the particle size of the particle 1b is set to 16 μm or less, which is two times the thickness of the foregoing negative electrode active material layer 1c. This enables the example shown in FIG. 2(b) to achieve the same advantageous effects as in the example shown in FIG. 2(a), in which sodium ions can be sufficiently occluded into and released from the negative electrode active material layer 1c.

Next, the negative electrode current collector 1a furnished with the negative electrode active material layer 1c or 1e, which contains germanium, is cut into a size of 2 cm×2 cm, and a negative electrode tab is attached thereto, to thus prepare a working electrode.

It is preferable that the pressure-rolled foil with a roughened surface has an arithmetical mean surface roughness Ra of from 0.1 μm to 10 μm. Arithmetical mean surface roughness Ra is defined in Japanese Industrial Standards JIS B 0601-1994. Arithmetical mean surface roughness Ra can be measured by, for example, a contact probe profilometer.

When the negative electrode active material layer is formed on the negative electrode current collector having surface irregularities in this way, the surface of the negative electrode active material layer is made to have a surface corresponding to the irregular surface of the negative electrode current collector.

When a battery that uses the negative electrode active material layer comprising either the polycrystalline germanium thin film having a film thickness of 8 μm or less or the germanium particles having a particle size of 16 μm or less undergoes a charge-discharge process, the stress associated with the expansion and shrinkage of the negative electrode active material layer concentrates at the surface irregularities of the negative electrode active material layer, causing a structural change in the polycrystalline germanium thin film or the germanium particles and forming gaps in the irregular surface portion of the negative electrode active material layer. Because of these gaps, the stress caused by the charge-discharge process is distributed. This allows reversible charge-discharge operations to be performed easily and makes good charge-discharge characteristics available.

(2) Preparation of Non-Aqueous Electrolyte

The non-aqueous electrolyte may be prepared by dissolving an electrolyte salt in a non-aqueous solvent.

Examples of the non-aqueous solvent include non-aqueous solvents commonly used for batteries, such as cyclic carbonic esters, chain carbonic ester, esters, cyclic ethers, chain ethers, nitrites, amides, and combinations thereof.

Examples of the cyclic carbonic esters include ethylene carbonate, propylene carbonate and butylenes carbonate. It is also possible to use a cyclic carbonic ester in which part or all of the hydrogen groups of the just-mentioned cyclic carbonic esters is/are fluorinated, such as trifluoropropylene carbonate and fluoroethyl carbonate.

Examples of the chain carbonic esters include dimethyl carbonate, ethyl methyl carbonate, diethyl carbonate, methyl propyl carbonate, ethyl propyl carbonate, and methyl isopropyl carbonate. It is also possible to use a chain carbonic ester in which part or all of the hydrogen groups of one of the foregoing chain carbonic esters is/are fluorinated.

Examples of the esters include methyl acetate, ethyl acetate, propyl acetate, methyl propionate, ethyl propionate, and γ-butyrolactone. Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ether.

Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butylphenyl ether, pentylphenyl ether, methoxytoluene, benzyl ethyl ether, diphenyl ether, dibenzyl ether, o-dimethoxybenzene, 1,2-diethoxyethane, 1,2-dibutoxy ethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile, and examples of the amides include dimethylformamide.

The electrolyte salt should not be a peroxide (such as NaClO₄) but should be an electrolyte salt that is soluble in the non-aqueous solvent and that offers a high level of safety and high thermal stability. Examples of the usable electrolyte salts include sodium hexafluorophosphate (NaPF₆), sodium tetrafluoroborate (NaBF₄), NaCF₃SO₃, and NaBeTi. The above-mentioned examples of the electrolyte salts may be used either alone or in combination.

The present embodiment employs a non-aqueous electrolyte in which sodium hexafluorophosphate as an electrolyte salt is added at a concentration of 1 mol/L to a mixed non-aqueous solvent of a 50:50 volume ratio of ethylene carbonate and diethyl carbonate.

(3) Preparation of Non-Aqueous Electrolyte Secondary Battery

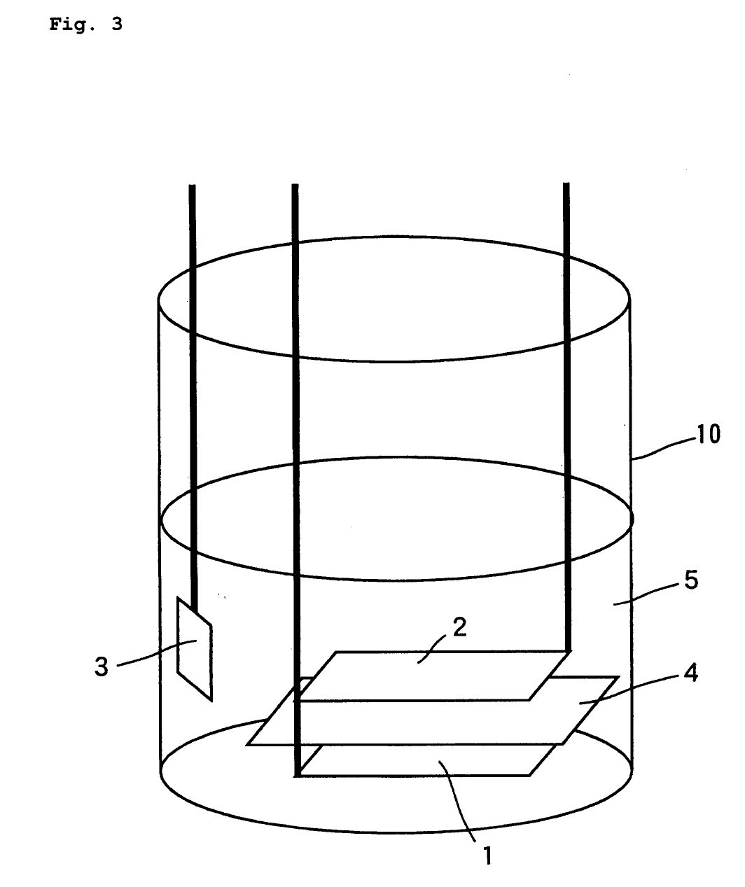

FIG. 3 is a schematic illustrative drawing illustrating a test cell of a non-aqueous electrolyte secondary battery according to the present embodiment.

In an inert atmosphere, a lead is attached, as illustrated in FIG. 3, to a working electrode 1 prepared in the foregoing manner, and likewise, a lead is attached to a counter electrode 2 made of, for example, metallic sodium. It should be noted that a counter electrode containing other materials such as a carbon material (such as hard carbon as disclosed in PCT/US2002/010775) and a conductive polymer that are capable of occluding and releasing sodium ions may be used in place of the counter electrode 2 made of metallic sodium.

Next, a separator 4 is interposed between the working electrode 1 and the counter electrode 2, and then, the working electrode 1 and the counter electrode 2 are disposed in a cell container 10, along with a reference electrode 3 made of, for example, metallic sodium. Thereafter, a non-aqueous electrolyte 5 prepared in the foregoing manner is filled in the cell container 10, to thereby prepare a test cell.

(4) Advantageous Effects Obtained in the Present Embodiment

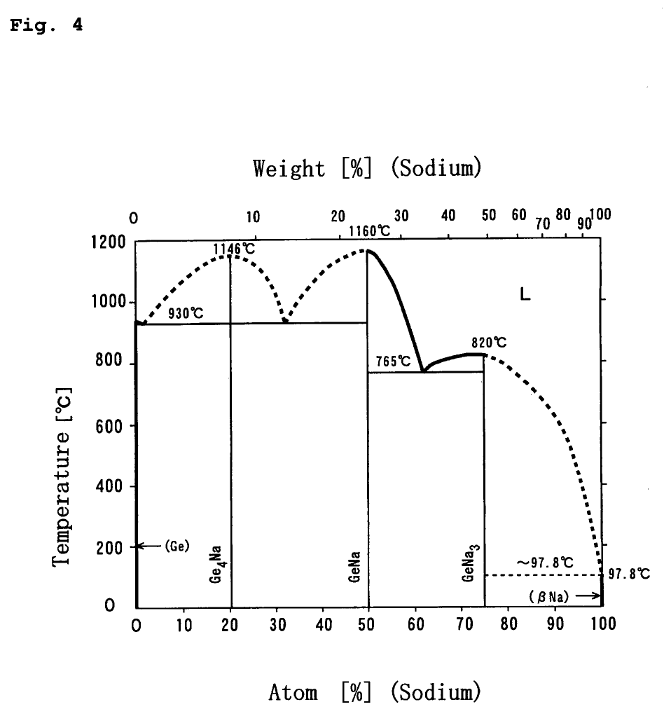

As seen from the two-phase diagram of germanium and sodium shown in FIG. 4, germanium and sodium are alloyed with each other. However, it was not known before the time of filing of the present application that whether germanium can occlude and release sodium ions.

The present embodiment makes it possible to obtain the following advantageous effects.

First, by using the working electrode 1 containing germanium as the main active material, sodium ions can be occluded into and released from the working electrode 1 sufficiently.

Second, a high discharge capacity density can be obtained either by setting the thickness of the negative electrode active material layer 1c of the working electrode 1 to be 8 μm or less, or by setting the particle size of the particles 1b in the negative electrode active material layer 1e in the working electrode 1 to be 16 μm or less.

Third, cost reduction in non-aqueous electrolyte secondary batteries can be achieved by using sodium, which is an abundant natural resource.

### EXAMPLES

### (a) Non-Aqueous Electrolyte Secondary Batteries of Examples 1-4

In Examples 1 to 4, test cells of the non-aqueous electrolyte secondary battery were fabricated in accordance with the above-described preferred embodiment, and the charge-discharge characteristics of the fabricated non-aqueous electrolyte secondary batteries were examined. In the examples, the negative electrode active material layer 1c, shown in FIG. 2(a), was formed on the negative electrode current collector 1a.

The thicknesses of the negative electrode active material layer 1c in Examples 1 to 4 were 0.5 μm, 1 μm, 6.3 μm, and 8 μm, respectively.

Each of the test cells was charged at a constant current of 0.1 mA until the potential of the working electrode 1 versus the reference electrode 3 reached 0 V. Then, each of the test cells was charged at a constant current of 0.1 mA until the potential of the working electrode 1 versus the reference electrode 3 reached 1.5 V. The charge-discharge characteristics of each test cell were examined in this way. The charge-discharge characteristics of Example 1 are discussed below as a representative example.

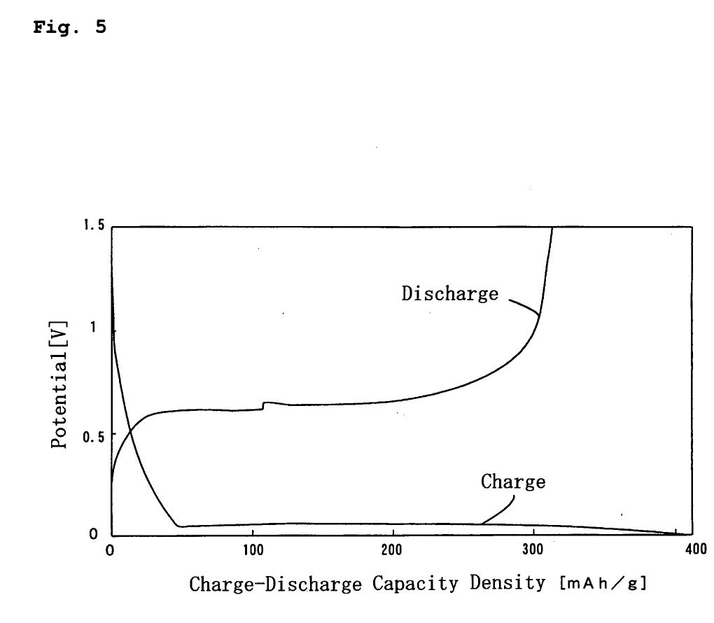

FIG. 5 is a graph illustrating the charge-discharge characteristics of the non-aqueous electrolyte secondary battery of Example 1.

As is seen from FIG. 5, the discharge capacity density per 1 g of the negative electrode active material of the working electrode 1 was about 312 mAh/g. This demonstrates that good charge-discharge operations were performed and a high discharge capacity density was obtained.

### (b) Non-aqueous Electrolyte Secondary Battery of Comparative Example

In the Comparative Example, a test cell of the non-aqueous electrolyte secondary battery was fabricated in accordance with the foregoing preferred embodiment, and the charge-discharge characteristics of the fabricated non-aqueous electrolyte secondary battery were examined. The negative electrode active material layer 1c, shown in FIG. 2(a), was formed on the negative electrode current collector 1a, as in Examples 1 to 4. In this Comparative Example, the thickness of the negative electrode active material layer 1c was 15 μm.

A charge-discharge test was conducted with the non-aqueous electrolyte secondary battery of Comparative Example in the same manner as with the foregoing Examples 1 to 4.

### (c) Evaluation

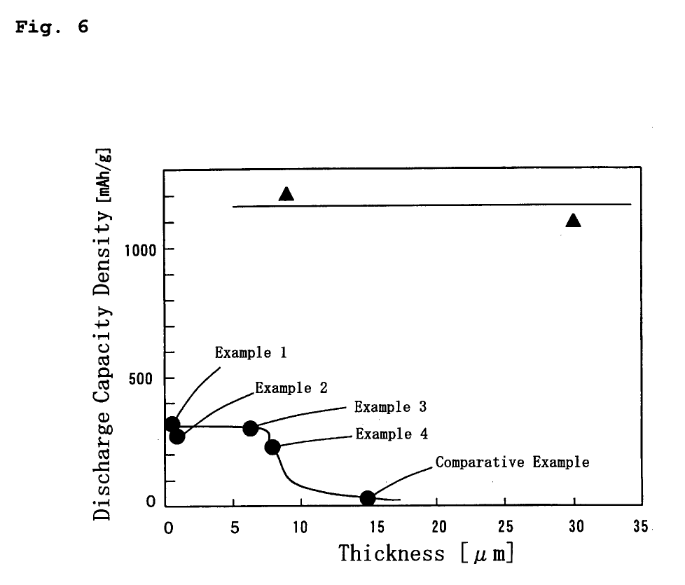

FIG. 6 is a graph illustrating the results of the charge-discharge tests for Examples 1 to 4 and Comparative Example.

As is seen from FIG. 6, it was confirmed that when the thickness of the negative electrode active material layer 1c is 8 μm or less (Examples 1 to 4), the discharge capacity density was higher than 200 mAh/g, so very high discharge capacities were obtained. The discharge capacities of the respective non-aqueous electrolyte secondary batteries of Examples 1 to 4 were 312 mAh/g, 280 mAh/g, 306 mAh/g, and 222 mAh/g, respectively.

In contrast, when the thickness of the negative electrode active material layer 1c exceeded 8 μm (Comparative Example: 15 μm), the discharge capacity density was significantly poor (Comparative Example: 28 mAh/g).

Thus, it was demonstrated that there is a tendency for the discharge capacity density to become poor when the thickness of the negative electrode active material layer 1c exceeds a certain value.

As is shown by the graph at the top of FIG. 6, when a counter electrode 2 made of metallic lithium was used in place of that made of metallic sodium, in other words, when lithium ions are occluded into and released from the working electrode 1, little variation was observed in the discharge capacity density versus the thickness of the negative electrode active material layer 1c.

Here, the discharge capacity of the carbon negative electrode used in the non-aqueous electrolyte secondary battery that utilizes lithium ions is 770 Ah/L (=350 [mAh/g]×2.2 [g/cc] (density of carbon)).

This means that a non-aqueous electrolyte secondary battery that has a higher capacity than the battery that uses a carbon negative electrode can be achieved if the germanium negative electrode (working electrode 1) used in the non-aqueous electrolyte secondary batteries utilizing sodium ions according to the embodiments of the invention has a discharge capacity density of greater than 140 mAh/g (≈770 [Ah/L]/5.4 [g/cc] (density of germanium)).

As in the cases of Examples 1 to 4, when the thickness of the negative electrode active material layer 1c was 8 μm or less, discharge capacities of higher than 200 mAh/g were achieved.

Accordingly, it was confirmed that the use of the working electrode 1 containing germanium makes is possible to obtain a non-aqueous electrolyte secondary battery that has a higher capacity than the non-aqueous electrolyte secondary battery using a carbon negative electrode.

It is also believed that in the cases of using the negative electrode active material layer 1e as shown in FIG. 2(b) as well, it is possible to obtain high discharge capacities similar to those achieved by Examples 1 to 4 when the particle size of particles 1b is 16 μm or less.

The non-aqueous electrolyte secondary battery according to the present invention may be used as a power source for various applications, such as portable power sources and power sources for automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese patent application No. 2006-174758 filed Jun. 26, 2006, which is incorporated herein by reference.

What is claimed is:

1. A non-aqueous electrolyte secondary battery comprising:
a positive electrode;
a non-aqueous electrolyte containing sodium ions; and
a negative electrode having a negative electrode active material layer, the negative electrode active material layer containing germanium as its main active material and having a thickness of 8 μm or less.

2. The non-aqueous electrolyte secondary battery according to claim 1, wherein the negative electrode active material layer is formed in a thin film by sputtering.

3. A non-aqueous electrolyte secondary battery comprising:
a positive electrode;
a non-aqueous electrolyte containing sodium ions; and
a negative electrode having a negative electrode active material layer, the negative electrode active material layer containing germanium having a particle size of 16 μm or less as its main active material.

4. The non-aqueous electrolyte secondary battery according to claim 2, wherein the negative electrode active material layer contains elemental germanium.

5. The non-aqueous electrolyte secondary battery according to claim 3, wherein the negative electrode active material layer contains elemental germanium.

6. The non-aqueous electrolyte secondary battery according to claim 2, wherein the negative electrode further comprises a metal current collector having a roughened surface, and the negative electrode active material layer is formed on the metal current collector having a roughened surface.

7. The non-aqueous electrolyte secondary battery according to claim 3, wherein the negative electrode further comprises a metal current collector having a roughened surface, and the negative electrode active material layer is formed on the metal current collector having a roughened surface.

8. The non-aqueous electrolyte secondary battery according to claim 6, wherein the metal current collector has an arithmetical mean surface roughness of from 0.1 μm to 10 μm.

9. The non-aqueous electrolyte secondary battery according to claim 7, wherein the metal current collector has an arithmetical mean surface roughness of from 0.1 μm to 10 μm.

10. The non-aqueous electrolyte secondary battery according to claim 1, wherein the non-aqueous electrolyte contains sodium hexafluorophosphate.

11. The non-aqueous electrolyte secondary battery according to claim 2, wherein the non-aqueous electrolyte contains sodium hexafluorophosphate.

12. The non-aqueous electrolyte secondary battery according to claim 3, wherein the non-aqueous electrolyte contains sodium hexafluorophosphate.

13. The non-aqueous electrolyte secondary battery according to claim 4, wherein the non-aqueous electrolyte contains sodium hexafluorophosphate.

14. The non-aqueous electrolyte secondary battery according to claim 5, wherein the non-aqueous electrolyte contains sodium hexafluorophosphate.

15. The non-aqueous electrolyte secondary battery according to claim 6, wherein the non-aqueous electrolyte contains sodium hexafluorophosphate.

16. The non-aqueous electrolyte secondary battery according to claim 7, wherein the non-aqueous electrolyte contains sodium hexafluorophosphate.

17. The non-aqueous electrolyte secondary battery according to claim 8, wherein the non-aqueous electrolyte contains sodium hexafluorophosphate.

18. The non-aqueous electrolyte secondary battery according to claim 9, wherein the non-aqueous electrolyte contains sodium hexafluorophosphate.
